(19) United States
(12) Patent Application Publication
(10) Pub. No.: US 2026/0363274 A1
(43) Pub. Date: Nov. 19, 2026

(54) Multi-Component Functional Feed Formula Composition

(71) Applicant: Chien-Chang KO, Kaohsiung City (TW)

(72) Inventor: Chien-Chang KO, Kaohsiung City (TW)

(73) Assignee: Chien-Chang KO, Kaohsiung City (TW)

(21) Appl. No.: 19/334,625

(22) Filed: Sep. 19, 2025

(30) Foreign Application Priority Data
May 16, 2025 (TW) 114118481

(51) Int. Cl. A23K 10/30; A23K 10/22; A23K 20/147; A23K 50/42

(52) U.S. Cl. CPC A23K 10/30; A23K 10/22; A23K 20/147; A23K 50/42

(57) ABSTRACT

A multi-component functional feed formula composition includes a base portion and an additive portion. The base portion is composed of fish powder, meat powder, or a mixture thereof. The additive portion is composed of one or more functional ingredients selected from: lingzhi (Ganoderma), Antarctic krill, pineapple, cranberry, collagen peptides, blueberry, turmeric root, eggshell membrane, Trametes versicolor (turkey tail; yunzhi), chaga (bai hua rong), white button mushroom, and Agaricus blazei (ji song rong). Based on nutritional needs for the gut, skin and coat, joints, and immune function, the formula can be categorized and paired accordingly. The ingredients in the additive portion are functionally complementary and can be selected according to product positioning, and can be configured in different structural arrangements for application in dry pet-food products, thereby providing multifunctional nutritional supplementation and application flexibility.

### CROSS-REFERENCE TO RELATED APPLICATION

This application is based on and claims priority to Taiwanese Patent Application No. 114118481, filed on May 16, 2025, the entire content of which is incorporated herein by reference.

### TECHNICAL FIELD

The present invention relates to feed formula combination technology, and particularly to a multi-component functional feed formula composition suitable for daily nutritional supplementation for pets such as dogs and cats. The composition includes a variety of functional ingredients that can be used in combination and designed according to different nutritional requirements, and is suitable for the manufacture and development of dry-type feed products.

### BACKGROUND

Most dry-type pet foods for dogs and cats on the market are generally designed around a single nutritional objective—for example, focusing on protein supplementation, skin and coat maintenance, or gastrointestinal regulation—making it difficult to cover multiple nutritional needs and functional support at the same time. Although some feed products add functional additives during processing, such additions are mostly one-off enhancements lacking an overall combination plan and classification logic, resulting in insufficient synergy among ingredients and difficulty ensuring the loading ratio and stability of functional ingredients within the pellets.

In addition, existing products mostly design only the appearance of the feed pellet structure; there is still a lack of specific designs and systematic considerations for technical elements such as functional stratification of multi-ingredient formulas, use classification, and pairing flexibility. Therefore, the market still lacks a feed product design solution that centers on a multi-component functional formula and provides classification and pairing logic.

### SUMMARY

An objective of the present invention is to provide a multi-component functional feed formula composition suitable for daily feeding of pets such as dogs or cats, and having multifunctional nutritional support. Compared with existing feed products designed mostly around a single nutritional objective, the present invention combines multiple ingredients with specific nutritional support effects so that a single pellet can simultaneously cover different nutritional aspects such as gut function, joint mobility, skin and coat maintenance, and physiological defense, thereby enhancing product completeness and market value.

The composition comprises a base portion and an additive portion. The base portion is composed of fish-derived or meat-derived powders, providing protein and the primary nutritional source. The additive portion is composed of one or more selected from lingzhi (also known as Ganoderma), Antarctic krill, pineapple, cranberry, collagen peptides, blueberry, turmeric root, eggshell membrane, Trametes versicolor (also known as turkey tail and yunzhi), chaga (also known as bai hua rong), white button mushroom, and Agaricus blazei (also known as ji song rong). Users may select and combine these ingredients per formulation needs to form targeted functional nutritional supplements.

To provide greater formulation flexibility and design versatility in practice, the invention further discloses functional classification schemes for the ingredients: cranberry is suitable for supporting gut health; collagen peptides and blueberry are suitable for skin and coat care; eggshell membrane and turmeric root support joint health; lingzhi, Trametes versicolor, and chaga are suitable for balancing physiological defense functions. In order to accommodate regulatory restrictions in different markets, Trametes versicolor may be replaced by white button mushroom, and chaga may be replaced by Agaricus blazei, while maintaining stability and commercialization flexibility.

The additive portion ingredients are selected from the claims and can be combined in one or more to suit actual product needs; the pairing ratio of the functional ingredients can be adjusted. The amount added may range from 10 mg to 1000 mg per kilogram of feed, thereby achieving different formulation applications such as general daily wellness, specialized functional types, or staged nutrition types. Through the above combination logic and classification design, the invention improves design flexibility and application diversity of functional feed products, and enhances the nutritional coverage and absorption efficiency provided in daily feeding.

In sum, by combining multiple ingredients with functional nutritional effects according to classification logic and forming a composition with flexible combinations and stable ratios within the feed pellets, the invention can provide nutritional support for gut health, skin and coat care, joint maintenance, and physiological defense as needed, and can further extend to daily wellness, function-enhanced, or special formulation feed products in response to market tiering demands, thereby improving product development flexibility and overall nutritional benefits in pet feeding.

Additionally, the ingredients of the additive portion are combined according to respective nutritional supplementation objectives and exhibit functional complementarity and application synergy. For example, when cranberry and Antarctic krill are used together, both gut function and immune regulation can be addressed; the combination of collagen peptides and turmeric root can support joint tissues while providing antioxidant protection. Through such synergistic formulation logic, the feed pellets can provide diversified nutritional supplementation simultaneously, improving integration and stability of actual feeding effects.

### BRIEF DESCRIPTION OF THE DRAWINGS

FIG. 1 is an illustration of the multi-component functional feed formula composition of the present invention.

FIG. 2 is a cross-section structural diagram of a first embodiment of the feed pellet of the present invention.

FIG. 3 is a cross-section structural diagram of a second embodiment of the feed pellet of the present invention.

FIG. 4 is a cross-section structural diagram of a third embodiment of the feed pellet of the present invention.

FIG. 5 is a cross-section structural diagram of a fourth embodiment of the feed pellet of the present invention.

### LIST OF REFERENCE SYMBOLS

100: multi-component functional feed formula composition
1: base portion
2: additive portion

### DETAILED DESCRIPTION OF THE EMBODIMENTS

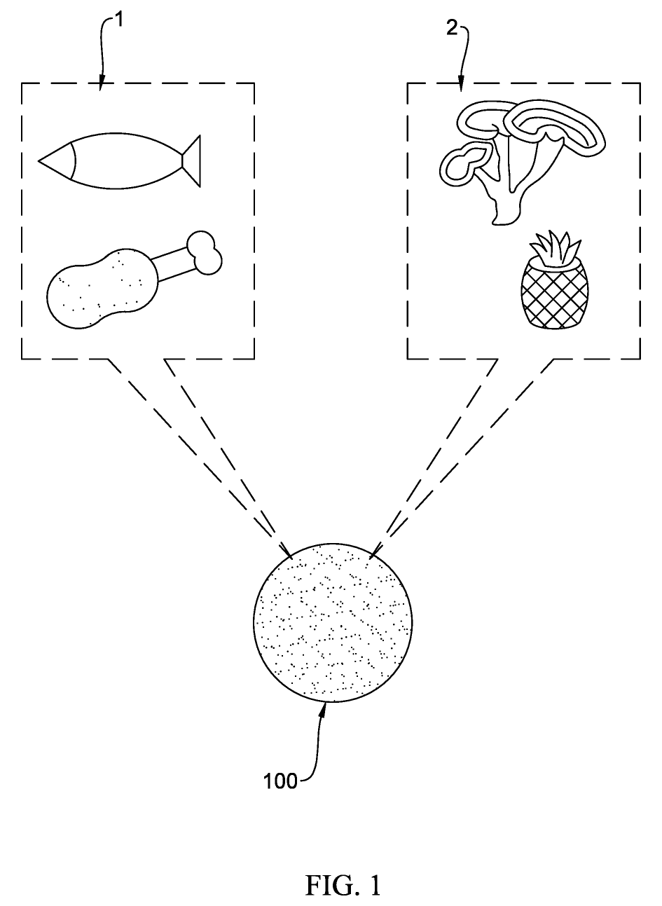

As shown in FIG. 1, the multi-component functional feed formula composition 100 of the invention is designed by pairing a base portion 1 with an additive portion 2. The base portion 1 may be selected from fish powder, meat powder, or a mixture thereof, to provide the main nutritional source and pellet structure; the additive portion 2 is a composition containing functional raw materials selected from one or more of lingzhi (Ganoderma), Antarctic krill, cranberry, collagen peptides, blueberry, turmeric root, eggshell membrane, Trametes versicolor, chaga, white button mushroom, and Agaricus blazei.

The additive portion 2 can be designed according to functional classification, for example: pineapple and cranberry for gut support; Antarctic krill for immune regulation; collagen peptides and blueberry for skin and coat care; eggshell membrane and turmeric root for joint health; and lingzhi, Trametes versicolor, and chaga for balancing physiological defense functions. In one embodiment, in order to include all of the benefits above, the additive portion 2 consists of pineapple, cranberry, Antarctic krill, collagen peptides, blueberry, eggshell membrane, turmeric root, lingzhi, Trametes versicolor, and chaga. In another embodiment, to address regulatory or market needs, Trametes versicolor may be replaced with white button mushroom, and chaga may be replaced with Agaricus blazei, providing stable alternative options. In one example, when Trametes versicolor and chaga are both replaced, the additive portion 2 consists of pineapple, cranberry, Antarctic krill, collagen peptides, blueberry, eggshell membrane, turmeric root, lingzhi, white button mushroom, and Agaricus blazei.

The ingredients of the additive portion are combined according to respective nutritional supplementation purposes and exhibit functional complementarity and application synergy—for instance, joint use of cranberry and Antarctic krill helps address gut function and immune regulation; combining collagen peptides with turmeric root can support joint tissues while offering antioxidant protection. With such synergistic formulation logic, the pellets can simultaneously provide diversified nutritional supplementation, improving overall integration and stability of feeding outcomes.

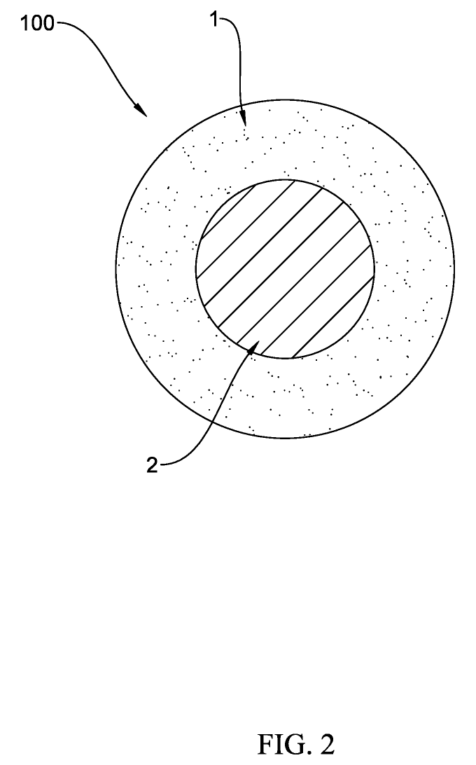

As shown in FIGS. 2–5, the base portion 1 and the additive portion 2 can be loaded and integrated in processing using different structural configurations. Specifically, the pellets may adopt one of the following configuration modes.

FIG. 2 illustrates a cross-section structural diagram of a first embodiment of the feed pellet having a coated structure. The additive portion 2 is disposed inside the pellet, with the outer layer formed by the base portion 1.

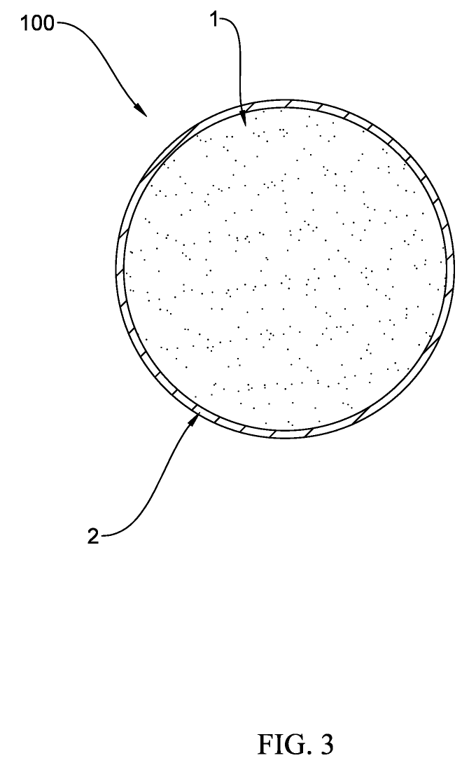

FIG. 3 illustrates a cross-section structural diagram of a second embodiment of the feed pellet having a reverse-coated structure. The base portion 1 is internal, and the additive portion 2 forms an outer encapsulating layer.

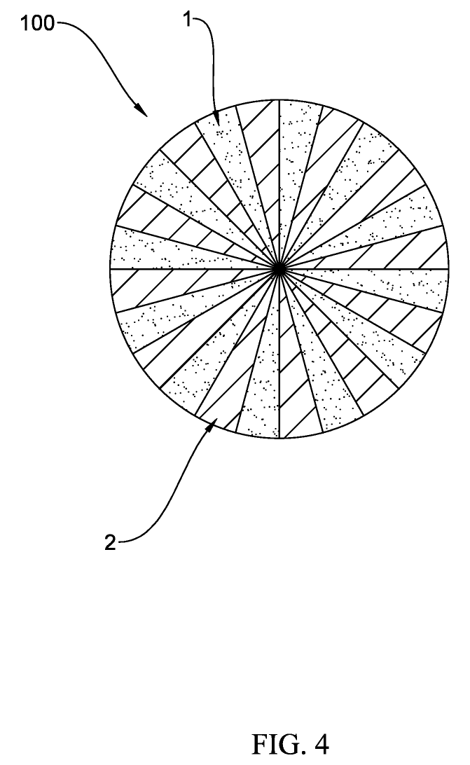

FIG. 4 illustrates a cross-section structural diagram of a third embodiment of the feed pellet having a mixed structure. The base portion 1 and the additive portion 2 are alternatively arranged within the pellet, forming a non-homogeneous distribution. In specific, the feed pellet 100 has a generally circular periphery and is partitioned into multiple wedge-shaped sectors that extend radially from a central node to the outer edge. The sectors are formed of base portions 1 and additive portions 2, alternatively. The interfaces between adjacent sectors are substantially radial, so that the base portions 1 and the additive portions 2 are interleaved in a spoke-like pattern around the full circumference, each sector terminating flush with the pellet’s perimeter and converging at the central region to yield a substantially uniform, alternating distribution.

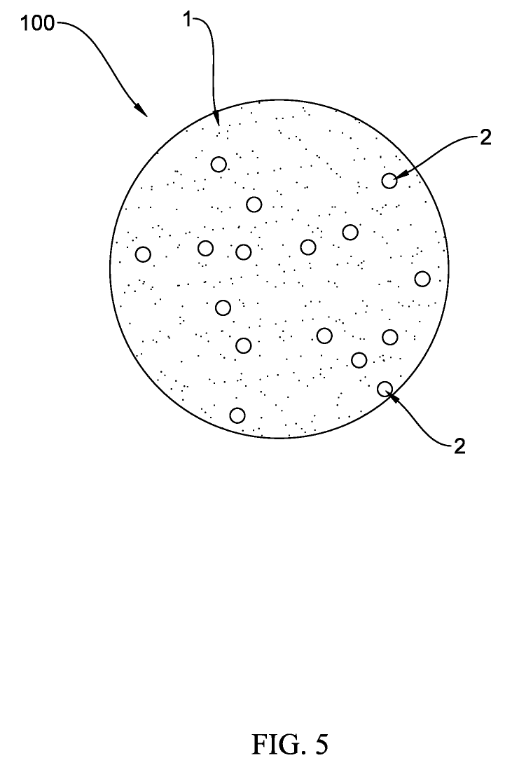

FIG. 5 illustrates a cross-section structural diagram of a fourth embodiment of the feed pellet having an embedded structure. The base portion 1 forms the pellet body, while the additive portion 2 is preformed as microgranules and dispersedly embedded within the pellet body.

The above structural configurations may be selected according to processing conditions, raw material properties, and product design needs, and are not limited to any particular pairing mode. In practice, functional stratification may also be employed to mount different functional additives in zoned microgranular form, or compaction steps may be used to ensure stability and absorption efficiency of the ingredients.

The composition may be applied in various feed components and structural combinations to design products meeting different pet nutritional requirements. For example, the functional formulation carried in the additive portion may include one or more of the following effects: assisting intestinal peristalsis, promoting digestion and absorption, modulating gut microbiota, enhancing skin and coat luster, maintaining joint function, strengthening immunity, protecting the urinary system, or delaying aging. Selection and design may be performed according to product positioning and target animals to achieve overall multifunctional nutritional benefits.

The above are specific embodiments and the technical principles employed. Changes made according to the concept of the present invention that do not depart from the spirit covered by the description and drawings shall all fall within the scope of the present invention.

What is claimed is:

1. A multi-component functional feed formula composition comprising:
a base portion, and
an additive portion,
wherein the base portion is composed of fish powder, meat powder, or a mixture thereof, and provides a primary nutritional source;
wherein the additive portion comprises a composition composed of one or more selected from lingzhi, Antarctic krill, cranberry, collagen peptides, pineapple, blueberry, turmeric root, eggshell membrane, Trametes versicolor, chaga, white button mushroom, and Agaricus blazei; and
wherein the composition is a multi-ingredient compound formula designed to promote balance of daily metabolic functions and nutritional supplementation for pets.

2. The multi-component functional feed formula composition according to claim 1, wherein the additive portion comprises pineapple and/or cranberry.

3. The multi-component functional feed formula composition according to claim 1, wherein the additive portion comprises collagen peptides and/or blueberry.

4. The multi-component functional feed formula composition according to claim 1, wherein the additive portion comprises eggshell membrane and/or turmeric root.

5. The multi-component functional feed formula composition according to claim 1, wherein each ingredient of the additive portion is at a ratio of 10 mg/kg to 1000 mg/kg to the composition.

6. The multi-component functional feed formula composition according to claim 1, wherein the additive portion comprises white button mushroom.

7. The multi-component functional feed formula composition according to claim 1, wherein the additive portion comprises Agaricus blazei.

8. The multi-component functional feed formula composition according to claim 1, wherein the additive portion consists of pineapple, cranberry, Antarctic krill, collagen peptides, blueberry, eggshell membrane, turmeric root, lingzhi, Trametes versicolor, and chaga.

9. The multi-component functional feed formula composition according to claim 1, wherein the additive portion consists of pineapple, cranberry, Antarctic krill, collagen peptides, blueberry, eggshell membrane, turmeric root, lingzhi, white button mushroom, and Agaricus blazei.

10. The multi-component functional feed formula composition according to claim 1, wherein the additive portion consists of pineapple, cranberry, Antarctic krill, collagen peptides, blueberry, eggshell membrane, turmeric root, lingzhi, Trametes versicolor, and Agaricus blazei.

11. The multi-component functional feed formula composition according to claim 1, wherein the additive portion consists of pineapple, cranberry, Antarctic krill, collagen peptides, blueberry, eggshell membrane, turmeric root, lingzhi, white button mushroom, and chaga.
